(19) United States
(12) Patent Application Publication
(10) Pub. No.: US 2012/0325924 A1
(43) Pub. Date: Dec. 27, 2012

(54) APPARATUS AND METHOD FOR APPLYING A FLUID TO A SURFACE

(75) Inventor: Gregory D. Baltus, Pittsburgh, PA (US)

(73) Assignee: AMERICAN ROADPRINTING, LLC, Pittsburgh, PA (US)

(21) Appl. No.: 13/508,001

(22) PCT Filed: Nov. 4, 2010
(86) PCT No.: PCT/US10/55358

§ 371 Date: May 3, 2012

Related U.S. Application Data
(60) Provisional application No. 61/258,022, filed on Nov. 4, 2009.

(51) Int. Cl. B05B 13/02; B05B 15/00

(52) U.S. Cl. 239/1; 239/722; 239/73

(57) ABSTRACT

A fluid application apparatus, a spray head system, and a method of applying a fluid to a surface are disclosed. The fluid application apparatus, the spray head system, and the method involve applying a fluid to a surface and adjusting the spray header system between a transport configuration and an application configuration, wherein the adjusting modifies a distance between the spray header system and the surface.

### PRIORITY

The present disclosure claims priority to and benefit of U.S. Provisional Patent Application Number 61/258,022, filed Nov. 4, 2009, and titled “APPARATUS AND METHOD FOR APPLYING A FLUID TO A SURFACE,” which is hereby incorporated by reference in its entirety.

### FIELD

The present disclosure is generally directed to an apparatus and method for dispensing or applying a fluid to a surface. More particularly, the present disclosure is directed to applying or spraying a marking solution to a surface to print an information pattern.

### BACKGROUND

Surfaces, such as pavement, commonly include an information pattern to convey information. Information patterns may be in the form of symbols, words, or combinations thereof. For example, information patterns may include arrows or letters, such as “stop”. Additionally, information patterns may include company logos or trademarks.

One approach to applying information patterns includes marking a pavement surface using a stencil and using an application device (for example, a paint gun or brush) to apply paint to pattern-defining apertures of the stencil. However, this approach suffers from several drawbacks. For example, this approach can be inadequate in protecting workers from airborne solvents or air-particulate as the information pattern is applied, this approach can take a long time, this approach can require substantial set up resulting in reduced mobility, this approach can limit the pattern applied based upon the stencil used, and combinations thereof.

Another approach involves utilizing hand-held devices such as is disclosed in U.S. Pat. No. 6,062,686, which is hereby incorporated by reference in its entirety. The hand-held device disclosed in U.S. Pat. No. 6,062,686 suffers from several drawbacks. For example, the hand-held device is limited in size to a medium that is the size of paper or a poster and the hand-held device is not equipped to print on a rough surface.

Another approach involves utilizing global positioning systems (GPS) such as is disclosed in U.S. Pat. No. 6,299,934, which is hereby incorporated by reference in its entirety. The GPS system suffers from drawbacks that it is unable to provide positioning precision and accuracy to form a desirable image.

Yet another approach is disclosed in U.S. Pat. No. 6,951,375, which is hereby incorporated by reference in its entirety. U.S. Pat. No. 6,951,375 involves marking a surface to accurately determine the size of a large area, scanning the marking of the surface, and applying an image. Such an approach suffers from several drawbacks. For example, marking the surface delays the process of applying paint to the surface. Also, scanning the marking requires that the device include a scanner and corresponding systems for analyzing the surface. In addition, the device described in U.S. Pat. No. 6,951,375 involves an apparatus that moves in a non-linear manner, thereby extending the duration of the application process.

What is needed is a method and apparatus that does not suffer from the drawbacks of the prior art and, for example, is capable of applying a fluid to a surface that can be applied while protecting workers, can be done quickly, can be done without substantial set up, can apply several patterns, and combinations thereof.

### SUMMARY OF THE INVENTION

According to an exemplary embodiment, a fluid application apparatus includes a spray head system configured to be raised to a transport configuration and lowered toward an application configuration for applying a fluid to a surface.

According to another exemplary embodiment, a spray head system is configured to be raised to a transport configuration and lowered toward an application configuration for applying a fluid to a surface.

According to another exemplary embodiment, a method of applying a fluid to a surface includes adjusting a spray header system between a transport configuration and an application configuration, wherein the adjusting modifies a distance between the spray header system and the surface.

An advantage of an embodiment includes being capable of applying a fluid to a surface without harming workers.

Another advantage of an embodiment includes applying fluid to a surface at a quicker rate in comparison to previous methods.

Another advantage of an embodiment includes versatility allowing fluid to be applied to a surface without substantial set up and allowing fluid to be applied in numerous patterns without on-site set up.

Another advantage of an embodiment includes additional protection of mechanical features by including adjustability between a transport configuration and an application configuration.

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 illustrates a perspective view of an apparatus in a transport configuration according an exemplary embodiment of the disclosure.

FIG. 2 illustrates a perspective view of an apparatus without a housing in a transport configuration according an exemplary embodiment of the disclosure.

FIG. 3 illustrates a top view of an apparatus without a housing in a transport configuration according an exemplary embodiment of the disclosure.

FIG. 4 illustrates a side view of an apparatus without a housing in a transport configuration according an exemplary embodiment of the disclosure.

FIG. 5 illustrates a rear view of an exemplary embodiment of an apparatus without a housing in a transport configuration according to the disclosure.

FIG. 6 illustrates a side view of an apparatus without a housing in an application configuration an exemplary embodiment of the disclosure.

FIG. 7 illustrates a rear view of an apparatus without a housing in an application configuration an exemplary embodiment of the disclosure.

FIG. 8 illustrates a bottom perspective view of an exemplary embodiment of an apparatus without a housing in an application configuration according to an exemplary embodiment the disclosure.

FIG. 8A illustrates an enlarged section A of FIG. 8 according to an exemplary embodiment of the disclosure.

Wherever possible, the same reference numbers will be used throughout the drawings to represent the same parts.

### DETAILED DESCRIPTION OF THE INVENTION

Embodiments of the present disclosure provide a method and apparatus that does not suffer from the drawbacks of the prior art and, for example, is capable of applying a fluid to a surface that can be applied while protecting workers, can be done quickly, can be done without substantial set up, can apply several patterns, and combinations thereof. The method and apparatus reduce or eliminate delays in the process of applying paint to the surface, avoid using expensive or heavy components such as scanners for analyzing the surface, and are capable of printing in a substantially linear manner, thereby expediting the duration of the application process.

According to the disclosure, the medium or surface can be any size, can be rough, or a combination thereof. The surface may be any surface, such as a road surface, suitable for receiving the applied fluid. In one embodiment, the surface is a road surface, and the fluid is applied in a controlled pattern to form an information pattern. In another embodiment, the fluid is applied onto the surface in multiple passes. The information pattern may include symbols and/or words. The precision and accuracy of embodiments of the present disclosure permit formation of a desirable image. In one embodiment, the information pattern may include, but is not limited to company logos, trademarks, symbols, and lettering. The resolution of the information pattern may be a predetermined resolution (for example, permitting discernible viewing from up to about 1 foot away, up to about 10 feet away, up to about 100 feet away, or between about 10 feet and about 100 feet away).

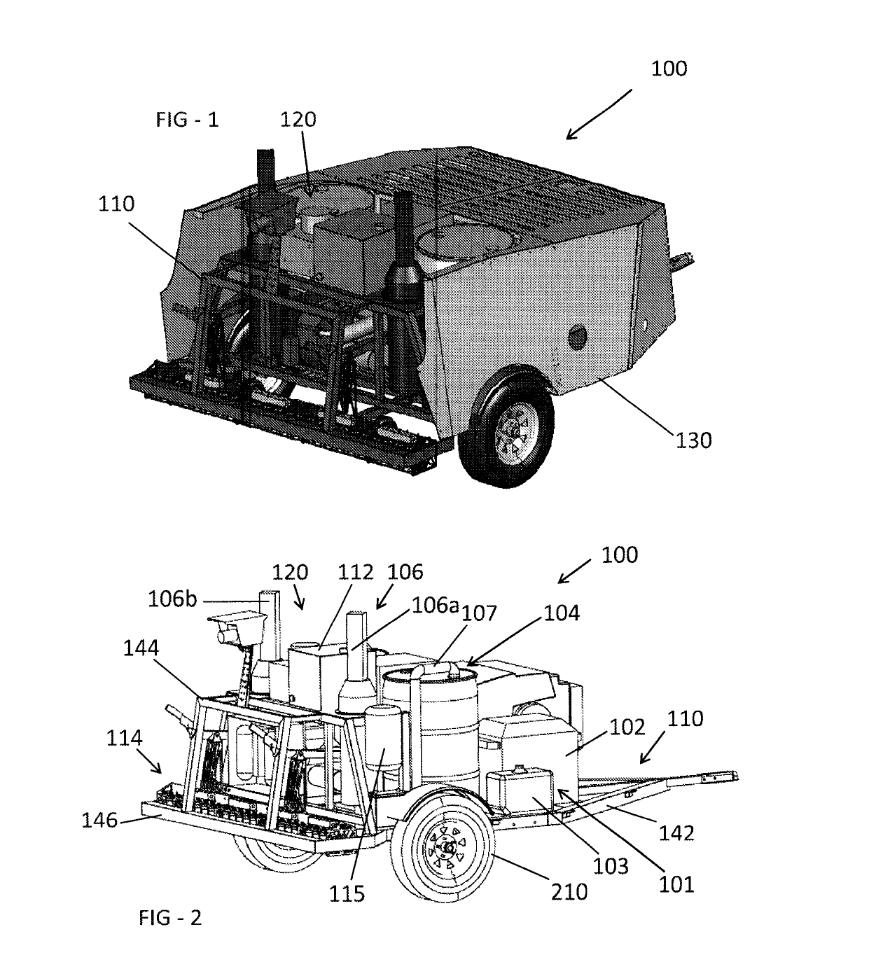

FIG. 1 shows an exemplary embodiment of an apparatus 100 according to the disclosure in a transport configuration. As can be seen in FIG. 1, the apparatus 100 includes a frame 110, a fluid application system 120 supported by the frame 110, and a housing 130 attached to the frame 110. The frame 110 is attached to two wheels 210. In another embodiment, the frame 110 may be attached to. two or more wheels 210. The housing 130 may provide a surface for markings, such as advertisement or logos. In another embodiment, the housing 130 may be omitted.

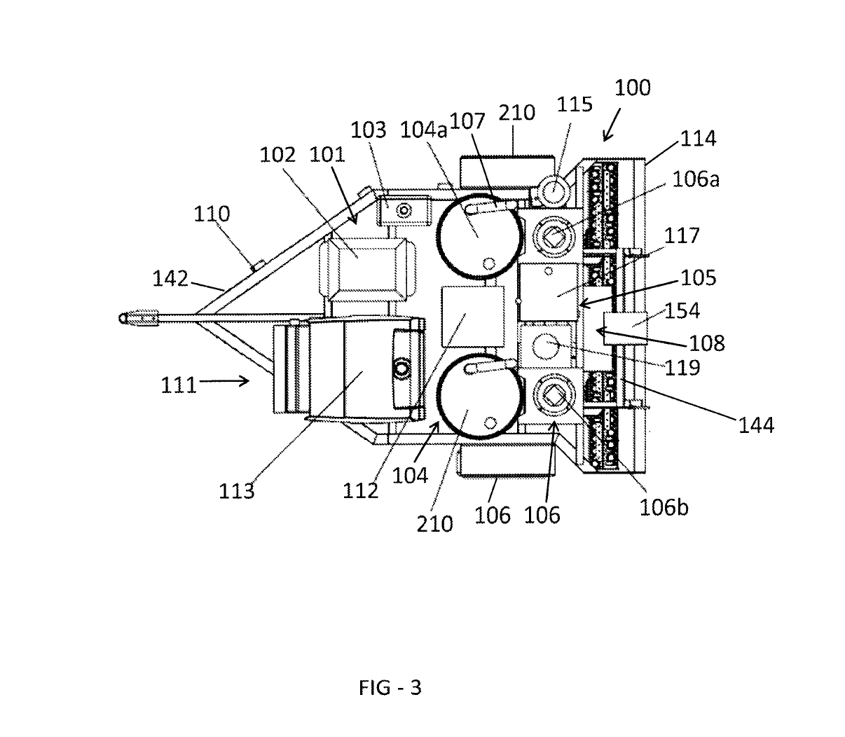

FIGS. 2-5 show various views and/or embodiments of the apparatus 100 in a transport configuration with the housing 130 (FIG. 1) removed to facilitate viewing of the various components. As is best shown in FIG. 3, the fluid application system 120 includes a power unit 101, a fluid supply 104, a hydraulic system 105, a fluid pumping system 106, a control system 108, a pneumatic system 111, and a spray head system 114.

Referring to FIGS. 2-3, the power unit 101 includes a power generator 102 and a power unit fuel supply 103. The frame 110 includes a main frame section 142 and a spray head frame section 144. The spray head frame section 144 includes rear bumper 146. Referring specifically to FIG. 3, in one embodiment, the fluid supply 104 includes a first fluid supply container 104a and a second fluid supply container 104b. In other embodiments, the fluid supply 104 may include one or more fluid supply containers.

In the embodiment shown in FIG. 3, the hydraulic system 105 includes an oil accumulator 115, an oil reservoir 117, and a oil coiler 119. The hydraulic system 105 operates by transporting oil between the oil reservoir 117 and the oil coiler 119 with the oil accumulator 115 permitting a predetermined pressure and/or flow rate to be maintained.

In the embodiment shown in FIG. 3, the fluid pumping system 106 includes a first pump 106a and a second pump 106b. In another embodiment, the fluid pumping system 106 may include one or more pumps. The pumping system 106 further includes a fluid distribution system 107. The fluid distribution system 107 provides fluid communication between the fluid supply 104 and the spray head system 114. The fluid distribution system 107 may include fluid distribution components such as, but not limited to piping, valves, and manifolds.

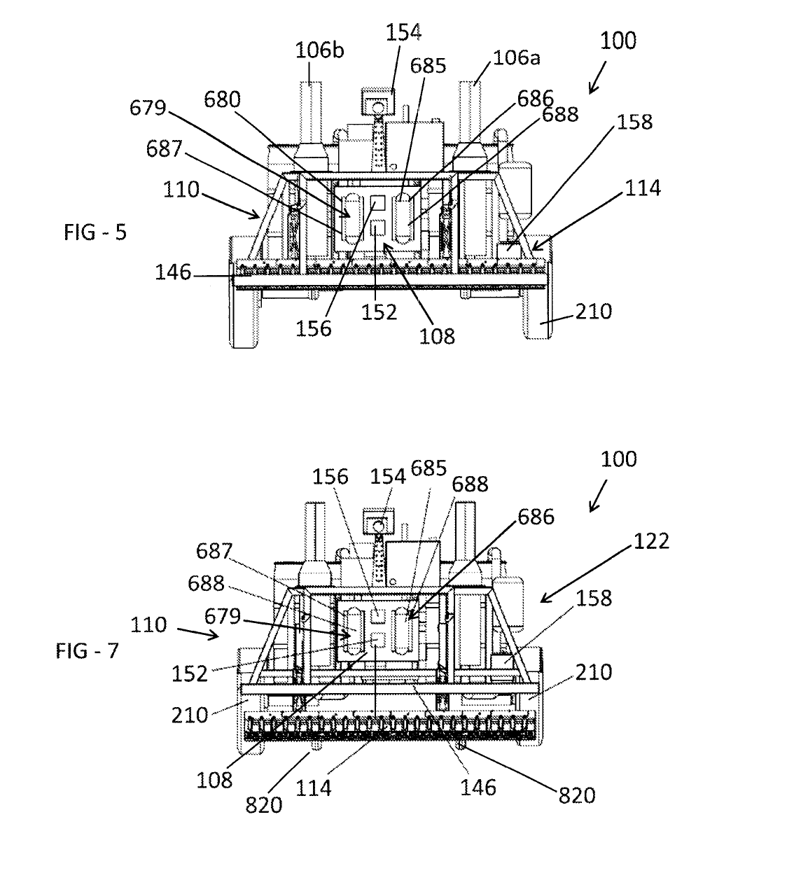

Referring to FIG. 5, the control system 108 includes a microprocessor 152, a video recording unit 154 (for example, permitting remote operation and/or remote interactivity), valve drive electronics 156 and a power supply 158. The microprocessor 152 may be a computer, central processing unit (CPU) or electronic circuit board capable of executing command functions. The microprocessor 152 may include an input device, such as, but not limited to one or more USB ports, one or more ethernet ports, one or more disk drives, or combinations thereof. In one embodiment, the input device may include a wireless system for receiving data input for the control system 108. The microprocessor 152 may also include .a keyboard or other manual data entry device to manually receive a data input or commands. The microprocessor 152 may further include a monitor for monitoring the input data and/or operational data of the apparatus 100. The power supply 158 may be a battery.

The microprocessor 152 may include a memory module. The memory module may include an internal memory module, an external memory module, or a combination thereof. For example, the memory module may be RAM, ROM or other memory for receiving and storing coded programs for executing the method of the present disclosure.

The control system 108 further includes a machine control interface that communicates with the microprocessor 152 and various encoders that drive the various components of the fluid application system 120, including the power unit 101, the fluid supply 104, the hydraulic system 105, the pumping system 106, the pneumatic system 111, and the spray head system 114. For example the microprocessor 152 provides control inputs to the valve drive electronics 156 to control hydraulic and pneumatic valves in the hydraulic system 105 and pneumatic system 111, respectively.

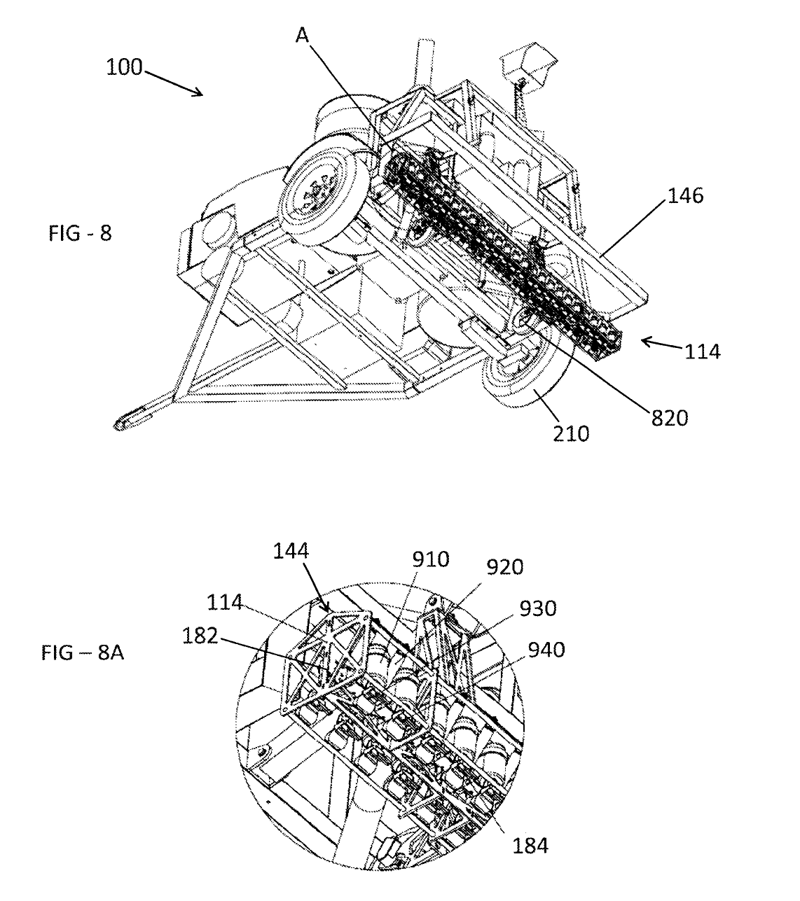

The control system 108 includes data or accepts data corresponding to the information pattern applied or sprayed by the spray head system 114. The control system 108 includes command functions for controlling the operation of the airless spray guns 910 (FIG. 8A) to spray or print the information pattern.

Referring again to FIG. 3, in one embodiment, the pneumatic system 111 includes a first air accumulator 112 and an air compressor 113. As shown in FIG. 5, the pneumatic system 111 further includes a second air accumulator system 679 and an air valve system 686. The second air accumulator system 679 includes a first small volume air accumulator 680 and a second small volume air accumulator 685. The air valve system 686 includes a first air valve system 687 and a second air valve system 688.

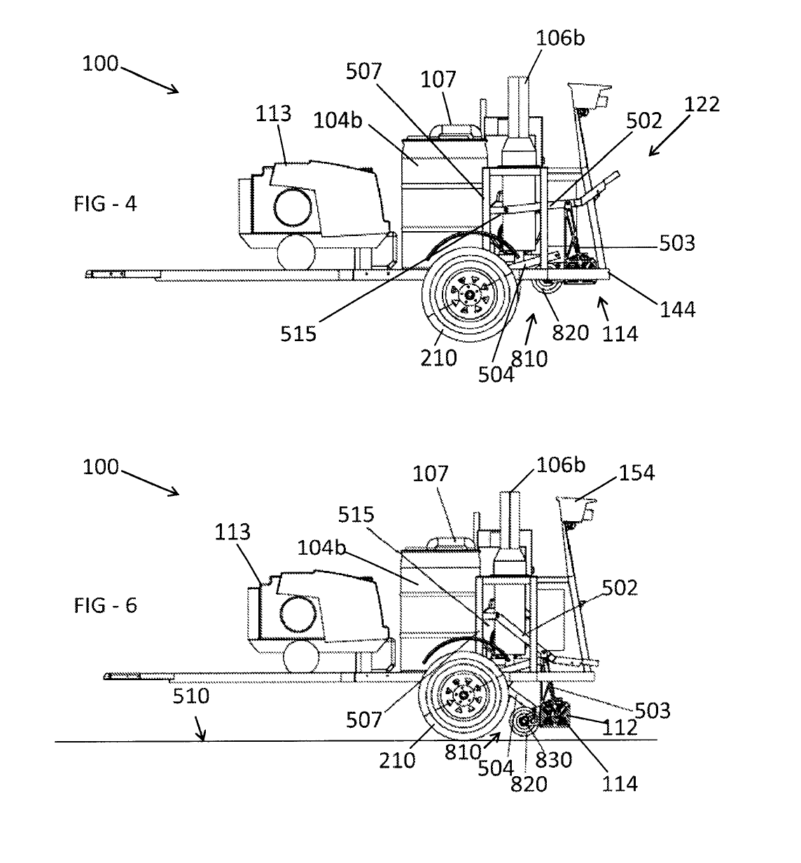

Referring to FIG. 4, in one embodiment, the apparatus 100 further includes a spray head system position assembly 122. The spray head system 114 is disposed substantially within the spray head frame section 144 in the transport configuration. The spray head system position assembly 122 includes a first bar linkage 502, a second bar linkage 503, a third bar linkage 504, a fourth bar linkage 507 and an actuator 515 configured to lower the spray head system 114 into the spray or application configuration position. The actuator 515 may be a motor, hydraulic device, pneumatic device or other positioning component that can be actuated to lower and raise the spray head system 114 to and from the application configuration. In another embodiment, the spray head system position assembly 122 may include an electrical device, a pneumatic device, another suitable device, or any suitable combination thereof to lower and raise the spray head system 114. In yet another embodiment, the spray head system position assembly 122 may additionally or alternatively be manually lowered and raised.

The apparatus 100 further includes a position indication device 810 attached to the spray head system position assembly 122. The position indication device 810 can be any suitable mechanical device capable of identifying a relative position for the apparatus 100. In one embodiment, the position indication device 810 is substantially devoid of electronic components thereby increasing the ability of the apparatus to avoid damage from rough road surfaces. The position indication device 810 includes an encoder caster wheel 820 and an encoder 830. The position indication device 810 provides position data to the control system 108 (FIG. 5). The position data may include, but is not limited to, the distance of travel of the apparatus 100 and speed of travel of the apparatus 100. As can be seen in FIG. 7, which shows an embodiment of the apparatus 100 in an application configuration, the apparatus 100 further includes a caster wheel 822 attached to the spray head system position assembly 122. The caster wheel 822 assists in positioning the spray head system 114 at a consistent distance from the surface 510. In another embodiment, the apparatus 100 may include one or more caster wheels 822.

FIGS. 6-8A show various views and/or embodiments of the apparatus 100 in a spray or application configuration with the housing 130 removed to facilitate viewing of the various components. Referring to FIG. 6, the spray head system 114 can be lowered to a spray configuration position proximate a surface 510. Such raising and lowering of the spray head system 114 permits the apparatus 100 to be moved at a faster speed while in transport configuration while substantially protecting the spray heat system 114 from damage. In addition, such raising and lowering permits the spray head system 114 to apply fluid with a high resolution. The spray head system 114 is lowered by actuating the actuator 515 and moving the first bar linkage 502, the second bar linkage 503, and the third bar linkages 504 to a lowered position. In the lowered position, the encoder caster wheel 820 contacts the surface 510 providing position data to the control system 108 (FIG. 5). In another embodiment, in lowered position the encoder caster wheel 820 and one or more additional the caster wheels 822 contact the surface 510.

Referring to FIG. 8A, the spray head system 114 includes an airless spray gun 910, a filter 920, a nozzle guard 930, and a nozzle 940. In one embodiment, the filter 920- is a paint filter. The spray head frame section 144 includes a spray head main frame section 182 and a spray gun guard 184.

In an exemplary method of operating the apparatus 100, the apparatus 100 is adjusted from the transport configuration (FIGS. 1-5) to the application configuration (FIGS. 6-8) by lowering or deploying the spray head system 114. In one embodiment, the spray head system 114 may be lowered in response to a command in the data input (for example, as discussed above with reference to FIG. 5).

The apparatus 100 is put in motion by an outside force (not shown), such as, but not limited to a truck, car, tractor or other self-propelled vehicle. As the apparatus 100 moves, the encoder caster wheel 820 informs the control system 108 of the relative position of the spray head system 114 to the surface 510. A dump valve is automatically actuated, which pressures the hydraulic system 105, which in turn pressurizes the fluid system via the pumping system 106. As the apparatus 100 continues to move, the control system 108 actuates the pneumatic valve system 686 in a computed pattern. Each valve (not shown) is tied to a spray gun 910. As each spray gun 910 is pneumatically pressurized, a pneumatic cylinder in the gun opens a zero-flow valve, which releases pressurized fluid to be applied to the surface 510.

The surface 510 may be a suitable surface for receiving the applied fluid. In one embodiment, the surface 510 may be a manufactured surface, such as, but not limited to an asphalt, concrete, artificial turf, or other suitable surface. In another embodiment, the surface 510 may be a natural surface such as a grass surface or field surface.

The fluid may be selected from a group including, but not limited to, a marking fluid, a cleaning fluid, a fertilizer solution, or combinations thereof. In one embodiment, the marking fluid may be a paint, dye, ink or other suitable marking liquid. The marking fluid may be a permanent or temporary marking liquid.

In one embodiment, the spray head system 114 is a print head, the fluid is a marking fluid, and the surface is a manufactured surface. The apparatus 100 applies the marking fluid to the surface 510 in a controlled manner to form a controlled or information pattern upon the surface 510.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A fluid application apparatus (100), comprising a spray head system (114) configured to be raised to a transport configuration and lowered toward an application configuration for applying a fluid to a surface (510).

2. The apparatus (100) of claim 1, wherein the apparatus (100) is capable of applying a plurality of patterns of information.

3. The apparatus (100) of claim 2, wherein the apparatus (100) is configured to apply the plurality of patterns of information in a single pass.

4. The apparatus (100) of claim 1, wherein the apparatus (100) is capable of applying the fluid in a substantially linear manner.

5. The apparatus (100) of claim 1, wherein the spray header system (114) is supported by a frame (144), the frame (144) being attached to two or more wheels.

6. The apparatus (100) of claim 1, further comprising a microprocessor (152), a video recording unit (154), valve drive electronics (156), and a power supply (158).

7. The apparatus (100) of claim 6, further comprising a control system (108) including a machine control interface that communicates with the microprocessor (152).

8. The apparatus (100) of claim 7, wherein the microprocessor (152) provides control inputs to the valve drive electronics (156) for applying the fluid.

9. The apparatus (100) of claim 1, wherein the spray header system (114) is configured to be raised and lowered by a device selected from the group consisting of an electrical device, a pneumatic device, and a combination thereof.

10. The apparatus (100) of claim 1, wherein the spray header system (114) is configured to be raised and lowered manually.

11. The apparatus (100) of claim 1, further comprising a position indication device.

12. The apparatus (100) of claim 11, wherein the position indication device is a mechanical device capable of identifying a relative position of the apparatus.

13. The apparatus (100) of claim 12, wherein the position indication device (810) comprises an encoder caster wheel (820) and an encoder (830).

14. The apparatus (100) of claim 1, wherein the apparatus (100) is configured to be put in motion by an outside force.

15. The apparatus (100) of claim 1, wherein the apparatus (100) is configured to apply an informational pattern in a single pass.

16. A spray head system (114) configured to be raised to a transport configuration and lowered toward an application configuration for applying a fluid to a surface (510).

17. The system (114) of claim 16, wherein the system (114) is capable of applying a plurality of patterns of information.

18. The system (114) of claim 16, wherein the system (114) is capable of applying the fluid in a substantially linear manner.

19. A method of applying a fluid to a surface, comprising adjusting a spray header system (114) between a transport configuration and an application configuration, wherein the adjusting modifies a distance between the spray header system (114) and the surface.

20. The method of claim 19, further comprising spraying a controlled pattern upon the surface.
